(19) United States
(12) Patent Application Publication
(10) Pub. No.: US 2020/0238643 A1
(43) Pub. Date: Jul. 30, 2020

(54) RECOVERY METHOD OF AUTOMOBILE PANEL USING SHAPE MEMORY POLYMER

(71) Applicants: Hyundai Motor Company, Seoul (KR); Kia Motors Corporation, Seoul (KR); Sogang University Research & Business Development Foundation, Seoul (KR)

(72) Inventors: Dong-Eun CHA, Hwaseong-si (KR); Young-Wan KIM, Daejeon (KR); Dong-Choul KIM, Seoul (KR)

(73) Assignees: Hyundai Motor Company, Seoul (KR); Kia Motors Corporation, Seoul (KR); Sogang University Research & Business Development Foundation, Seoul (KR)

(21) Appl. No.: 16/598,573

(22) Filed: Oct. 10, 2019

(30) Foreign Application Priority Data
Jan. 24, 2019 (KR) 10-2019-0009290

(51) Int. Cl. B29C 73/00

(52) U.S. Cl. CPC B29C 73/00; B29L 2031/30; B29K 2995/0096

(57) ABSTRACT

A method of recovering a vehicle panel using a shape memory polymer, may include: applying an impact load to a panel of a shape memory polymer material at a temperature equal to or lower than a glass transition temperature; removing the impact load from the panel; providing a high-temperature environment at the glass transition temperature or greater than the glass transition temperature to the panel; and cooling the panel to room temperature.

### CROSS-REFERENCE TO RELATED APPLICATIONS

The present application claims priority to Korean Patent Application No. 10-2019-0009290, filed on Jan. 24, 2019, the entire contents of which is incorporated herein for all purposes by this reference.

### BACKGROUND OF THE INVENTION

### Field of the Invention

The present invention relates to a recovery method using a shape memory polymer, and more particularly, to an order of a recovery method.

### Description of Related Art

A shape memory effect refers to a phenomenon in which a shape memorized at a predetermined temperature is memorized and then transformed into another shape by applying an external stimulus and then returned to the memorized shape when heated. A shape memory material may include a shape memory alloy and a shape memory polymer. The shape memory polymer can be more elastically transformed than the shape memory alloy and also has an excellent strain recovery ability, and as a result, the shape memory polymer has been extensively studied.

FIG. 1 illustrates a three-dimensional shape recovery model of a viscoelastic fluid. Referring to FIG. 1, a general cycle of shape recovery may include step (1) of fixing a shape by applying a load at a high temperature, for example, a temperature equal to or greater than a glass transition temperature (Tg), a cooling step (2), step (3) of fixing transformation to a temporary state shape by removing the load, and step (4) of recovering a transformed shape to an original shape by raising an environmental temperature. However, when the shape memory polymer is used as a material of a vehicle panel, it is very difficult to apply the shape recovery model of FIG. 1. The reason is that it is extremely rare that a panel of a vehicle collides in an environment at a glass transition temperature or higher.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a shape recovery model which may be applied when a shock to a vehicle panel occurs in a temperature environment which the shock may generally occur.

Various aspects of the present invention are directed to providing a method of recovering a vehicle panel using a shape memory polymer, which may include: applying an impact load to a panel of a shape memory polymer material at a temperature equal to or lower than a glass transition temperature; removing the impact load from the panel; providing a high-temperature environment at the glass transition temperature or greater than the glass transition temperature to the panel; and cooling the panel to room temperature.

The temperature equal to or lower than the glass transition temperature may be the room temperature.

The panel may be viscoelastically transformed by the impact load.

The impact load may be applied at a speed of 25 mm/min or more and less than 50 mm/min.

Preferably, elongation at break of the panel may be equal to or less than 200%.

The impact load may be applied at a speed equal to or more than 150 mm/min.

The elongation at break of the panel may be equal to or less than 20%.

According to an exemplary embodiment of the present invention, a shape may be recovered even though a shock to a vehicle panel occurs at room temperature.

According to an exemplary embodiment of the present invention, a perfect shape may be recovered in a coating drying temperature range (including 85° C.) and under a constant temperature and humidity condition.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a three-dimensional shape recovery model of a viscoelastic fluid.

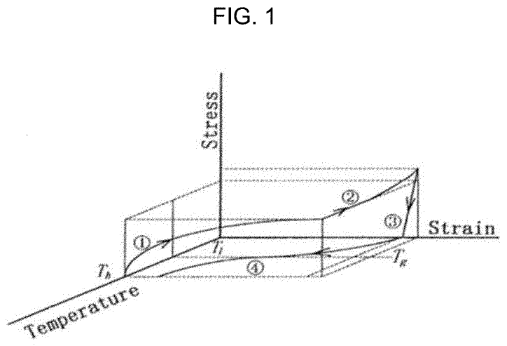

FIG. 2 illustrates a method of recovering a vehicle panel using a shape memory polymer and the resulting shape change and array of a polymer of a panel according to an exemplary embodiment of the present invention.

FIG. 3 illustrates ASTEM D638 Type 1 produced by injection molding for a tensile-recovery test.

FIG. 4A illustrates an initial length L₀ of Type 1, FIG. 4B illustrates a transformation length L₁ when tensile is applied to Type 1 of FIG. 4A, and FIG. 4C illustrates a recovery length L₂ when a temperature equal to or greater than a glass transition temperature is applied to Type 1 in FIG. 4B.

FIG. 5A illustrates experimental data obtained by measuring a yield strength with respect to a strain rate, FIG. 5B illustrates literature data of a yield strength for a strain rate corresponding to a high speed based on experimental data of FIG. 5A and a strain rate of 1/s, and FIG. 5C illustrates fitting data of the yield strength for a strain rate of 0 to 1000/s. FIG. 5D illustrates a comparison of a Cowper Symonds model and the experimental data.

FIG. 6A illustrates experimental data obtained by measuring an elongation at break with respect to the strain rate, FIG. 6B illustrates literature data of the elongation at break for the strain rate corresponding to the high speed based on the experimental data of FIG. 6A and the strain rate of 1/s, and FIG. 6C illustrates a true failure strength for a strain rate of approximately −8 to approximately 7 of natural logarithms. FIG. 6D illustrates an intersection point with a true failure strength curve, that is, a break point as a stress-strain curve.

FIG. 7 illustrates an elongation limit at which fracture does not occur, and an actual strain rate and an actual elongation portion of A and B actually subjected to a high-speed collision test.

FIG. 8 illustrates a snap fit fastening method according to an exemplary embodiment of the present invention.

FIG. 9 illustrates an order of a snap fit fastening method.

FIG. 10 is a side view of a vehicle air dam.

FIG. 11 illustrates an air dam provided with a heat transfer band.

FIG. 12 illustrates a temperature distribution of the air dam.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, the present invention will be described in detail. However, the present invention is not restricted or limited by exemplary embodiments and objects and effects of the present invention may be naturally appreciated or clearer by the following description and the objects and effects of the present invention are not limited only by the following disclosure. Furthermore, in describing the present invention, a detailed description of known technologies associated with the present invention may be omitted when it is determined to unnecessarily obscure the subject matter of the present invention.

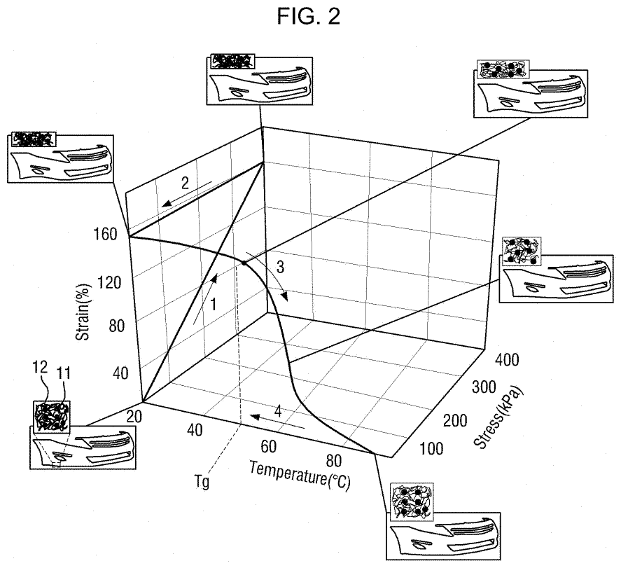

FIG. 2 illustrates a method of recovering a vehicle panel using a shape memory polymer and the resulting shape change and array of a polymer of a panel according to an exemplary embodiment of the present invention. Referring to FIG. 2, the present invention includes a step (1) of applying an impact load to a panel of a shape memory polymer material at a temperature equal to or lower than a glass transition temperature, a step (2) of removing the impact load, a step (3) of providing a high-temperature environment of the glass transition temperature or higher to the panel, and a step (4) of cooling the panel to room temperature. Furthermore, the temperature equal to or lower than the glass transition temperature may be the room temperature (approximately 20° C.).

The impact load is applied to a panel in an initial state before applying the load at the temperature equal to or lower than the glass transition temperature, for example, at the room temperature to cause plastic transformation and as such, the load is removed to fix the panel in a temporary transformation state. As such, when the panel is provided with a high-temperature environment at the glass transition temperature or higher to recover the transformation and the recovered panel is cooled and is subjected to a room temperature state, the panel is recovered and fixed to a panel shape in the initial state. In other words, the recover method according to an exemplary embodiment of the present invention may be referred to as an inverse model of the recovery model in the related art. Meanwhile, the panel of the shape memory polymer material is viscoelastically transformed and the shape memory polymer is a thermoplastic shape recovery plastic.

In an exemplary embodiment of the present invention, required elements to be utilized for actual panel collision-transformation-recovery include changed properties of a strain rate and a yield strength of a state in which the transformation occurs and changed properties of the strain rate and elongation break. Therefore, when the impact load is applied to the panel, it may be discriminated whether the recovery may be made within a range in which the breakage does not occur. To the present end, whether the recovery may be made needs to be derived through a tensile-recovery test. The tensile-recovery test is conducted under the assumption of constant temperature and humidity.

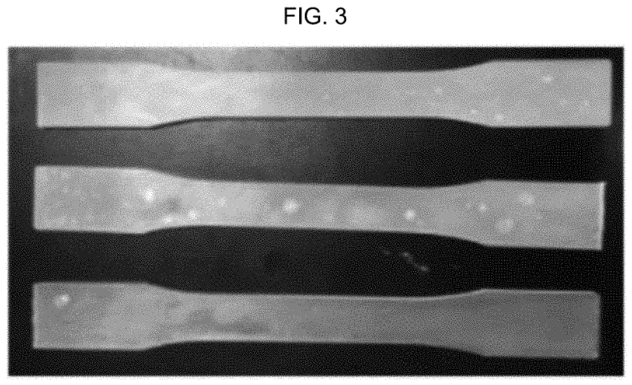

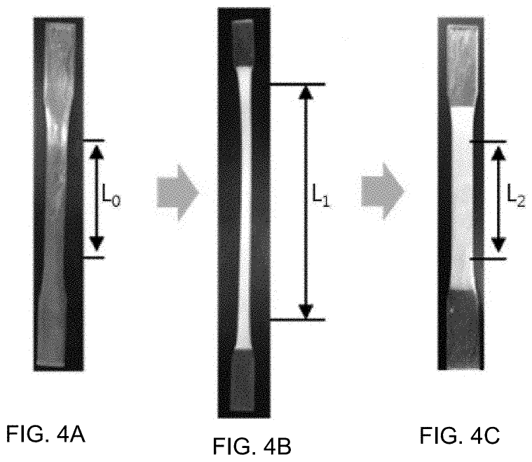

FIG. 3 illustrates ASTEM D638 Type 1 produced by injection molding for a tensile-recovery test. FIG. 4A illustrates an initial length L₀ of Type 1, FIG. 4B illustrates a transformation length L₁ when tensile is applied to Type 1 of FIG. 4A, and FIG. 4C illustrates a recovery length L₂ when a temperature equal to or greater than a glass transition temperature is applied to Type 1 in FIG. 4B. A recovery rate (%) is shown in Equation 1 below.

$$Recovery rate ( \% ) = \frac{{L}_{1} - {L}_{2}}{{L}_{1} - {L}_{0}} \times 100 \qquad [ Equation 1 ]$$

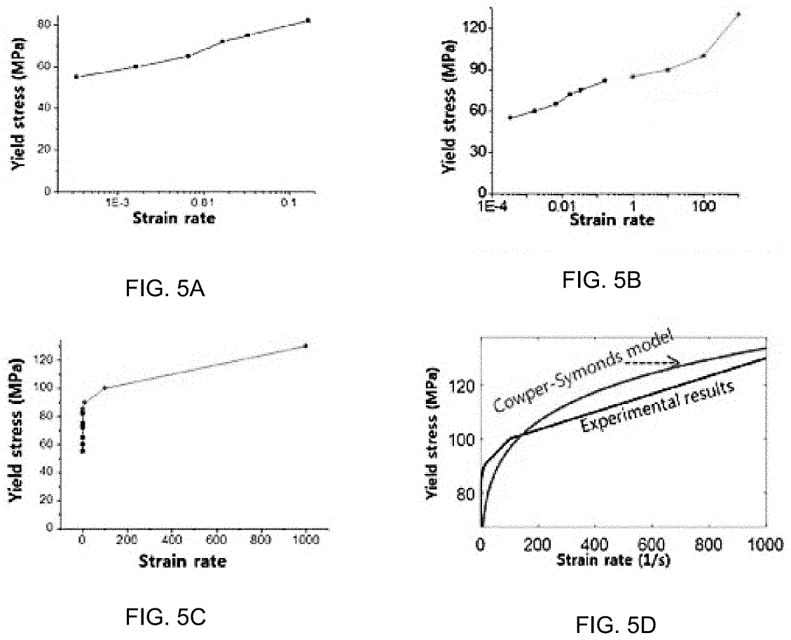

FIG. 5A illustrates experimental data obtained by measuring a yield strength with respect to a strain rate, FIG. 5B illustrates literature data of a yield strength for a strain rate corresponding to a high speed based on experimental data of FIG. 5A and a strain rate of 1/s, and FIG. 5C illustrates fitting data of the yield strength for a strain rate of 0 to 1000/s. FIG. 5D illustrates a comparison of a Cowper Symonds model and the experimental data.

The change properties of the strain rate and the yield strength are defined based on the Cowper Symonds model shown in Equation 2 below. According to FIG. 5A, FIG. 5B, FIG. 5C, and FIG. 5D, C=2.0 and P=7.0 of the Cowper Symonds model may be defined, so that Equation 3 may be defined.

$${σ}_{γ} = {{σ}_{0} [ 1 + \frac{\dot{ɛ}}{C} ]}^{1 / P} \qquad [ Equation 2 ]$$

σ_{γ}: Yield stress when applying corresponding strain rate

σ₀: Yield stress of minimum strain rate

ε: Strain rate

C, P: Cowper-Symonds parameter

$${σ}_{Y} = 5 {5 [ 1 + \frac{\dot{ɛ}}{2.0} ]}^{\frac{1}{7.0}} \qquad [ Equation 3 ]$$

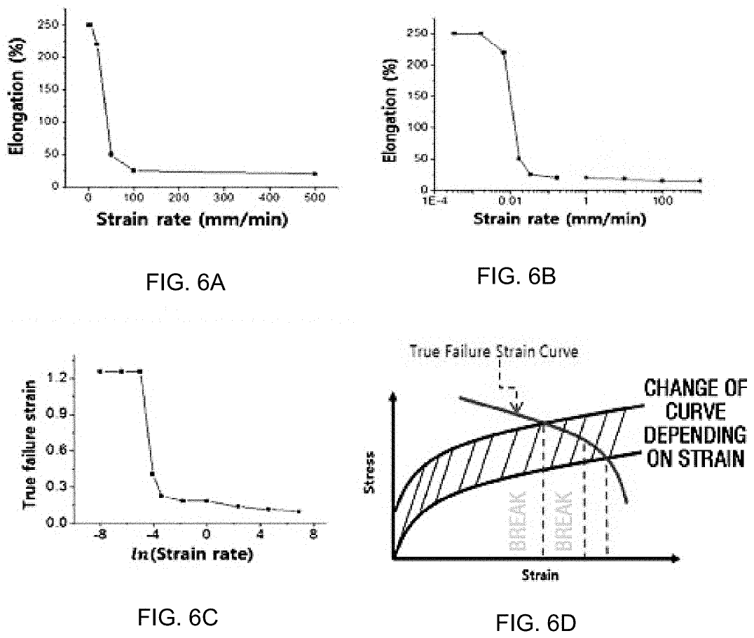

FIG. 6A illustrates experimental data obtained by measuring an elongation at break with respect to the strain rate, FIG. 6B illustrates literature data of the elongation at break for the strain rate corresponding to the high speed based on the experimental data of FIG. 6A, and FIG. 6C illustrates a true failure strength for a strain rate of approximately −8 to approximately 7 of natural logarithms. FIG. 6D illustrates an intersection point with a true failure strength curve, that is, a break point as a stress-strain curve. The change properties of the strain rate and the elongation at break are defined based on a True Failure Strain Curve model and according to FIG. 6A, FIG. 6B, FIG. 6C, and FIG. 6D, ε_{c} and εₑ of Equation 4 below may be limited to 1.1 ε_{c}<εₑ.

$$\begin{matrix}Von \text{-} Mises strain \text{:} {ɛ}_{c} & [ Equation 4 ] \\ {ɛ}_{c} = \frac{1}{\sqrt{2} ( 1 + v )} \sqrt{{( {ɛ}_{1} - {ɛ}_{2} )}^{2} + {( {ɛ}_{2} - {ɛ}_{3} )}^{2} + {( {ɛ}_{3} - {ɛ}_{1} )}^{2}} & \end{matrix}$$

ν: Poisson's ratio

ε_{c}: True failure strain obtained from test

Meanwhile, further referring to FIG. 6A, when the strain rate is less than a low-speed impact, that is, 50 mm/min, the strain rate showing the elongation at break of equal to or less than 200% is 25 or more and less than 50 mm/min and when the strain rate is equal to or greater than a high-speed impact, that is, 50 mm/min, the strain rate showing the elongation at break of 20% or less is equal to or greater than 150 mm/min. As described below, the method which is the present invention may be applied at the elongation at break of equal to or less than 200% and the elongation at break of 20% or less.

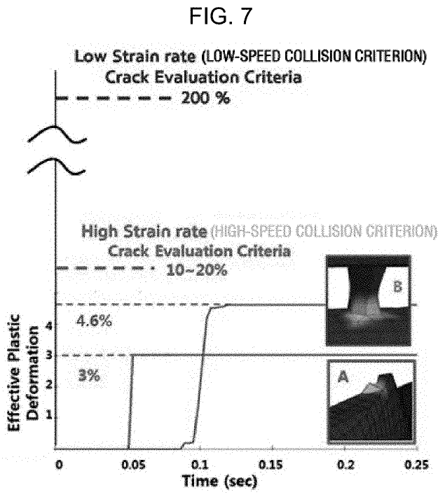

FIG. 7 illustrates an elongation limit at which fracture does not occur, and an actual strain rate and an actual elongation portion of A and B actually subjected to a high-speed collision test. Referring to FIG. 7, a guideline which shows 10 to 20% which is an elongation limit in which the break does not occur in a high-speed collision region, that is, the strain rate of 50 mm/min or more and a guideline which shows 200% which is an elongation limit in which the break does not occur in a low-speed collision region, that is, less than 50 mm/min are set. Of portions A and B in which the transformation occurs in the high-speed collision, since actual strain rate of portion B where largest transformation occurs is 4.6%, the following region where the break does not occur, that is, the following region is below 10%, and as a result, according to an exemplary embodiment of the present invention, a recovery of 95% or more may be made.

The change property of the yield strength and the change property of the elongation at break may be utilized in a step of deriving the property for analysis in a process of analyzing a panel low-speed impact and a recovery effective strain rate. When a maximum transformation portion of the panel is analytically analyzed for each collision mode, characteristics may be used in which the panel elongates in the transformation within 200% in the low-speed impact and when the break does not occur, the material is perfectly recovered. Furthermore, when the panel elongates in the transformation within 20% in the high-speed impact and the break does not occur, characteristics may be used in which the material is perfectly recovered. Therefore, as a discrimination criterion for shape recovery effectiveness, an analysis process may be defined, which may determine effective transformation of plastic transformation according to criteria of a low-speed region and a high-speed region.

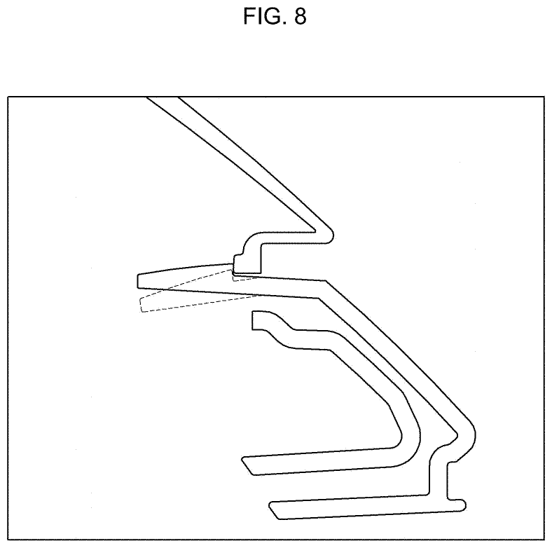

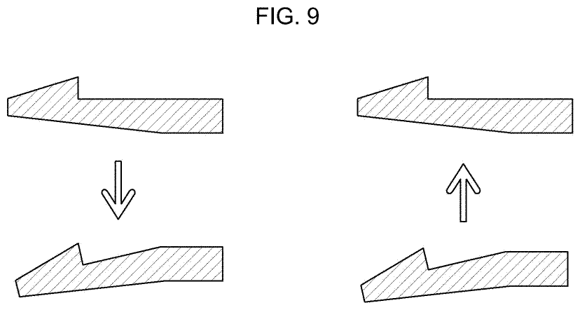

FIG. 8 illustrates a snap fit fastening method according to an exemplary embodiment of the present invention. FIG. 9 illustrates an order of a snap fit fastening method. Referring to FIG. 8 and FIG. 9, when a snap fit is artificially and forcibly removed, deformation occurs in the snap fit (see FIG. 9A). According to an exemplary embodiment of the present invention, the forcibly transformed snap fit is recovered at a temperature higher than the glass transition temperature to perfectly recover the transformed shape (see FIG. 9B). As a result, there is also an advantage that the snap fit may be reused.

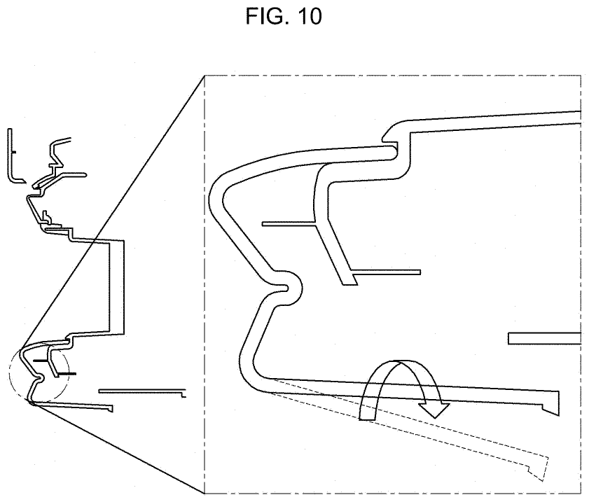

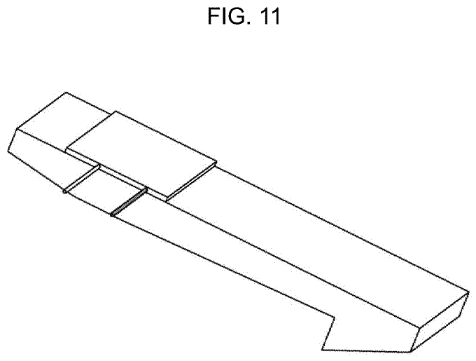

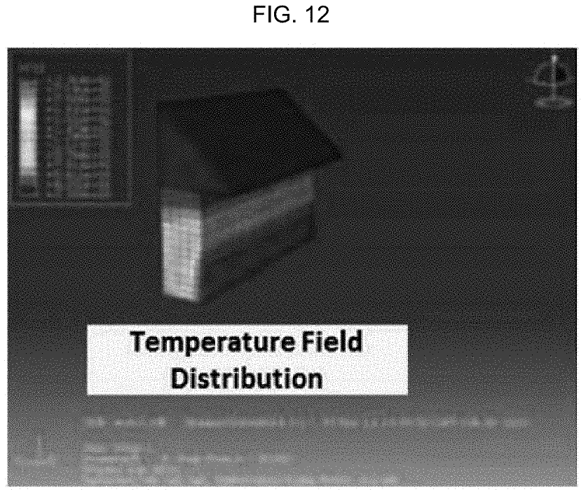

FIG. 10 is a side view of a vehicle air dam 20. FIG. 11 illustrates an air dam 20 provided with a heat transfer band 30. FIG. 12 illustrates a temperature distribution of the air dam. The air dam 20 is a component for aerodynamic performance of a vehicle. Table 1 shows power and a lowest temperature depending on a time of the heat transfer band.

TABLE 1

| | | | | |
|---|---|---|---|---|
| Time (sec) | 7 | 11 | 17 | 35 |
| Power (watt) | 0.050 | 0.030 | 0.020 | 0.010 |
| Lowest Temp. (° C.) | 84 | 84 | 86 | 86 |

Referring to FIG. 10, FIG. 11, and FIG. 12 and Table 1, to increase a projection area of the air dam 20, when the air dam is injection-molded and then, forcibly transformed and processed to a lowering location, which causes a temperature change of the air dam 20 to a range of the glass transition temperature or higher by transferring the power to the heat transfer band 30 attached to the internal to the air dam, a shape recovery function is performed to raise the location of the air dam 20, implementing an active aerodynamic mechanism function. Furthermore, the projection area is reduced, but a ground clearance is raised so that damage by a ground surface or an obstacle or a barrier of the ground may be prevented and the air dam may be interlocked with a logic for increasing the projection area only in high-speed traveling.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of recovering a panel using a shape memory polymer, the method comprising:
applying an impact load to the panel of a shape memory polymer material at a temperature equal to or lower than a glass transition temperature;
removing the impact load from the panel;
providing a high-temperature environment at the glass transition temperature or greater than the glass transition temperature to the panel; and
cooling the panel to room temperature.

2. The method of claim 1, wherein the temperature equal to or lower than the glass transition temperature is the room temperature.

3. The method of claim 1, wherein the panel is viscoelastically transformed by the impact load.

4. The method of claim 1, wherein the impact load is applied at a speed of 25 mm/min or more and less than 50 mm/min.

5. The method of claim 4, wherein elongation at break of the panel is equal to or less than 200%.

6. The method of claim 1, wherein the impact load is applied at a speed equal to or more than 150 mm/min.

7. The method of claim 6, wherein the elongation at break of the panel is equal to or less than 20%.

8. The method of claim 1, wherein a recovery target is configured to be forcibly transformed.

9. The method of claim 1, wherein the recovery target is an air dam which is forcibly transformed.

10. The method of claim 9, wherein a heat transfer band is mounted on the air dam.

11. The method of claim 1, wherein the recovery target is a snap fit.
